(19) United States
(12) Patent Application Publication
(10) Pub. No.: US 2022/0284345 A1
(43) Pub. Date: Sep. 8, 2022

(54) DEVICE FOR OPTIMIZING TRAINING INDICATOR OF ENVIRONMENT PREDICTION MODEL, AND METHOD FOR OPERATING SAME

(71) Applicant: Korea University Research and Business Foundation, Seoul (KR)

(72) Inventors: Yun Yeong OH, Busan (KR); Seong Taek YUN, Seoul (KR)

(73) Assignee: Korea University Research and Business Foundation, Seoul (KR)

(21) Appl. No.: 17/637,251

(22) PCT Filed: Aug. 19, 2020
(86) PCT No.: PCT/KR2020/011052

§ 371 Date: Feb. 22, 2022

(30) Foreign Application Priority Data
Aug. 19, 2019 (KR) 10-2019-0101069

(51) Int. Cl. G06N 20/00; G06K 9/62; G01W 1/10

(52) U.S. Cl. CPC G06N 20/00; G06K 9/6256; G06K 9/6298; G06K 9/6247; G01W 1/10

(57) ABSTRACT

The present invention relates to an apparatus for optimizing training indicators of an environmental prediction model and an operation method thereof. A training indicator optimization apparatus according to an embodiment includes a pre-processor for constructing a base dataset for environmental measurement data; a dynamic feature processor for identifying and extracting dynamic features for the constructed base dataset through multi-resolution wavelet analysis and a dimensionality reduction technique; a key feature group selector for identifying and evaluating driving force for environmental measurement data based on the extracted dynamic features and selecting a key feature group in response to the evaluation result; and an indicator optimizer for receiving the selected key feature group and the environmental measurement data as inputs and controlling a plurality of training indicators corresponding to an environmental prediction model.

### TECHNICAL FIELD

The present invention relates to an apparatus for optimizing training indicators including hyperparameters of an AI(artificial intelligence)-based environmental prediction model and an operation method thereof, and more particularly to a technical idea for optimizing hyperparameters of a deep learning algorithm that using integrated environment monitoring data.

### BACKGROUND ART

The long-short term neural network (LSTM) is known as one of the best algorithms suitable to AI-based real-time prediction model. It has been designed to solve the critical problems such as vanishing gradient and long-term memory dependency of classical recurrent neural networks (RNNs), and is successfully improved them through flexible weight control using the cell state and the forgot gate.

LSTM improves and controls the cell state using a sigmoid layer, called the gate, and a type of weight control functional group having a point-by-point combination. In particular, LSTM is characterized by having a very flexible adaptability, compared to conventional RNN, through selective update using a forgot gate.

There are various variations in LSTM. As representative examples thereof, there are Peenhole connection model (Gers and Schidhuber, 2000), Gated recurrent unit model (Cho et al., 2014), Depth gated RNN (Yao et al., 2015), and the like.

However, in spite of a lot of previous techniques and improved models, there is no accredited quantification technique as to which LSTM model is efficient depending on the feature of data and as to “optimization conditions for model training” that indicates best training conditions or options for optimal predictive performance Therefore, it is still mainly dependent on heuristic methods, such as trial and error methods based on individual users' experiences.

### DISCLOSURE

### Technical Problem

Therefore, the present invention has been made in view of the above problems, and it is one object of the present invention to provide a training indicator optimization apparatus capable of previously determining optimal training conditions according to data features and modeling purposes, and an operation method thereof.

It is another object of the present invention to provide a training indicator optimization apparatus capable of training time reduction, supporting intensive learning, and preventing overfitting on key features even for general LSTM models by priorly determining optimal training conditions, and an operation method thereof.

It is yet another object of the present invention to provide a training indicator optimization apparatus capable of further improving predictive ability through real-time model update according to input data even for existing LSTM models by previously determining optimal training conditions and, at the same time, providing a more efficient environmental prediction model for the implementation of an integrated environmental monitoring, interpretation, prediction and response system using various environmental data by presenting a quantitative basis for selecting an optimal training indicator, and an operation method thereof.

### Technical Solution

In accordance with an aspect of the present invention, the above and other objects can be accomplished by the provision of an apparatus for optimizing training indicators, including: i) a pre-processor for constructing a base dataset for environmental measurement data; ii) a dynamic feature processor for identifying and extracting dynamic features for the constructed base dataset through multi-resolution wavelet analysis and a dimensionality reduction technique; iii) a key feature group selector for identifying and evaluating driving force for environmental measurement data based on the extracted dynamic features and selecting a key feature group in response to the evaluation result; iv) and an indicator optimizer for receiving the selected key feature group and the environmental measurement data as inputs and controlling a plurality of training indicators corresponding to an environmental prediction model.

In accordance with an aspect, the environmental measurement data may include hydrological-environmental time series data measured in real-time, the hydrological-environmental time series data including at least one environmental data of hydrometeorological data, river water level data, groundwater level data, water quality data, temperature data, EC data, isotope ratio data, soil gas data and fine dust data.

In accordance with an aspect, the pre-processor may organize and align data matrices according to observation items and observation time resolution of a dataset of the environmental measurement data as the base dataset, may interpolate missing data by time-domain resolution or time interval for aligned data sets, and may standardize and normalize the noise-filtered results.

In accordance with an aspect, the dynamic feature processor may derive wavelet energy distribution data on a time-frequency domain through the multi-resolution wavelet analysis according to a time domain resolution for the constructed base dataset and may select potential environmental drivers (PEDs) by applying the dimensionality reduction technique to the derived wavelet energy distribution data.

In accordance with an aspect, the dynamic feature processor may extract variation features according to a time change for each time domain resolution of the selected PEDs and may extract and quantify the dynamic features based on the extracted variation features.

In accordance with an aspect, the dimensionality reduction technique may include at least one technique of principal/independent component analysis (PCA/ICA), time series factor analysis (TSFA), empirical mode decomposition (EMD) and multi-resolution state-space model (MRSSM).

In accordance with an aspect, the key feature group selector may determine a multi-resolution correlation between potential environmental driving force of the PEDs and the environmental measurement data and, in this case, may perform correlation determination that reflects time delay and phase change between the potential environmental driving force and the observed data and may select a maximum correlation scale between the potential environmental driving force and the observed data based on the performed correlation determination result.

In accordance with an aspect, the key feature group selector may identify driving force using a correlation between a wavelet energy ratio between the potential environmental driving force and the observed data and the selected maximum correlation scale, may evaluate relative contribution by processing linear coupling between a binding energy ratio of the selected maximum correlation scale and an explanatory power index of a dimensionality reduction model, and may select the key feature group based on the evaluated relative contribution.

In accordance with an aspect, the key feature group selector may build a pre-tuned LSTM network (well-tuned LSTM networks) that is trained using at least one of the PEDs and the key feature group, and may verify the potential environmental driving force using the pre-tuned LSTM network.

In accordance with an aspect, the indicator optimizer may build a long-short term memory network model using the key feature group and the environmental measurement data as inputs and may priorly quantify the plural training indicators based on a time-frequency domain of the key feature group.

In accordance with an aspect, the indicator optimizer may select at least one predictive model based on residual verification, based on complex model verification indicators of observations measured from the environmental measurement data and values predicted from the long-short term memory network model, and multi-resolution analysis of the residuals, and may quantify the plural pre-quantified training indicators based on one predictive model of the selected predictive models or a combined prediction model of two or more predictive models of the selected predictive models.

In accordance with an aspect, an indicator optimizer may construct a training indicator optimization model according to the features of original data using at least two training indicators of the plural quantified training indicators. For example, the original data may be environmental measurement data.

In accordance with an aspect, the plural training indicators may include a training period (T), a minibatch size (mbs), the number of hidden layers (HL) and the number of optimal epochs (E).

In accordance with another aspect of the present invention, there is provided a method of optimizing training indicators, the method including: constructing, by a pre-processor, a base dataset on environmental measurement data; identifying and extracting, by a dynamic feature processor, dynamic features for the constructed base dataset through multi-resolution wavelet analysis and a dimensionality reduction technique; identifying and evaluating, by a key feature group selector, driving force for environmental measurement data based on the extracted dynamic features from the key feature group selector and selecting a key feature group in response to the evaluation result; and receiving, by an indicator optimizer, the selected key feature group and the environmental measurement data as inputs and controlling a plurality of training indicators of an environmental prediction model.

In accordance with an aspect, the identifying and extracting of the dynamic features may further include deriving wavelet energy distribution data on a time-frequency domain through the multi-resolution wavelet analysis according to a time domain resolution for the constructed base dataset and selecting potential environmental drivers (PEDs) by applying the dimensionality reduction technique to the derived wavelet energy distribution data; and extracting variation features according to a time change for each time domain resolution of the selected PEDs and extracting and quantifying the dynamic features based on the extracted variation features.

In accordance with an aspect, the selecting of the key feature group may further include: when a multi-resolution correlation between potential environmental driving force of the PEDs and the environmental measurement data is determined, performing correlation determination reflecting time delay and phase change between the potential environmental driving force and the observed data and selecting a maximum correlation scale between the potential environmental driving force and the observed data based on the performed correlation determination result; and identifying driving force using a correlation between a wavelet energy ratio between the potential environmental driving force and the observed data and the selected maximum correlation scale, evaluating a relative contribution by processing linear coupling between a binding energy ratio of the selected maximum correlation scale and an explanatory power index of the dimensionality reduction model, and selecting the key feature group based on the evaluated relative contribution.

In accordance with an aspect, the controlling of the plural training indicators may further include: building a long-short term memory network model using the key feature group and the environmental measurement data as inputs and pre-quantifying the plural training indicators based on a time-frequency domain of the key feature group; selecting at least one predictive model based on residual verification, based on complex model verification indicators of observations measured from the environmental measurement data and values predicted from the long-short term memory network model, and multi-resolution analysis of the residuals, and post-quantifying the plural pre-quantified training indicators based on one predictive model of the selected predictive models or a combined prediction model of two or more predictive models of the selected predictive models; and constructing an optimal training indicator model using at least two training indicators of the plural quantified training indicators.

In accordance with an aspect, the plural training indicators may include at least one of a training period (T), a minibatch size (mbs), the number of hidden layers (HL) and the number of optimal epochs (E).

### Advantageous Effects

In accordance with an embodiment, optimal training conditions according to data features and modeling purposes can be priorly determined. In accordance with an embodiment, training time reduction and intensive learning and overfitting on key features can be prevented even for general LSTM models by priorly determining optimal training conditions.

In accordance with an embodiment, the predictive ability can be further improved through real-time model update on input data even for general LSTM models by priorly determining optimal training conditions and, at the same time, a more efficient environmental prediction model for the implementation of an integrated environmental monitoring, interpretation, prediction and response system using various environmental data can be provided by presenting a quantitative basis for selecting an optimal training indicator.

### DESCRIPTION OF DRAWINGS

FIG. 1 is a diagram for explaining an application concept of a training indicator optimization apparatus for optimizing training indicators of an environmental prediction model according to an embodiment.

FIG. 2 is a diagram for explaining the configuration of a training indicator optimization apparatus according to an embodiment.

FIGS. 3A to 3H are diagrams for explaining an embodiment of an operation of receiving soil gas as environmental measurement data by a training indicator optimization apparatus according to an embodiment.

FIGS. 4A to 4F are drawings for explaining an embodiment of an operation of receiving river/groundwater level (RWL/GWL) and electrical conductivity (RWEC/GWEC) measurement data as environmental measurement data by a training indicator optimization apparatus according to an embodiment.

FIGS. 5A to 5C illustrate an example of configuring an optimal training indicator model according to an embodiment.

FIG. 6 is a drawing for explaining a training indicator optimization method according to an embodiment.

### BEST MODE

Specific structural and functional descriptions of embodiments according to the concept of the present disclosure disclosed herein are merely illustrative for the purpose of explaining the embodiments according to the concept of the present disclosure. Furthermore, the embodiments according to the concept of the present disclosure can be implemented in various forms and the present disclosure is not limited to the embodiments described herein.

The embodiments according to the concept of the present disclosure may be implemented in various forms as various modifications may be made. The embodiments will be described in detail herein with reference to the drawings. However, it should be understood that the present disclosure is not limited to the embodiments according to the concept of the present disclosure, but includes changes, equivalents, or alternatives falling within the spirit and scope of the present disclosure.

The terms such as “first” and “second” are used herein merely to describe a variety of constituent elements, but the constituent elements are not limited by the terms. The terms are used only for the purpose of distinguishing one constituent element from another constituent element. For example, a first element may be termed a second element and a second element may be termed a first element without departing from the teachings of the present invention.

It should be understood that when an element is referred to as being “connected to” or “coupled to” another element, the element may be directly connected or coupled to the other element or intervening elements may be present. In contrast, when an element is referred to as being “directly connected to” or “directly coupled to” another element, there are no intervening elements present. Expressions describing the relationship between elements, for example, “between” and “directly between” or “directly adjacent to”, etc., should be interpreted in similar manners.

The terms used in the present specification are used to explain a specific exemplary embodiment and not to limit the present inventive concept. Thus, the expression of singularity in the present specification includes the expression of plurality unless clearly specified otherwise in context. Also, terms such as “include” or “comprise” should be construed as denoting that a certain characteristic, number, step, operation, constituent element, component or a combination thereof exists and not as excluding the existence of or a possibility of an addition of one or more other characteristics, numbers, steps, operations, constituent elements, components or combinations thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred embodiments of the present invention will be described in detail with reference to the accompanying drawings. However, the scope of the present invention is not limited by these embodiments. Like reference numerals in the drawings denote like elements.

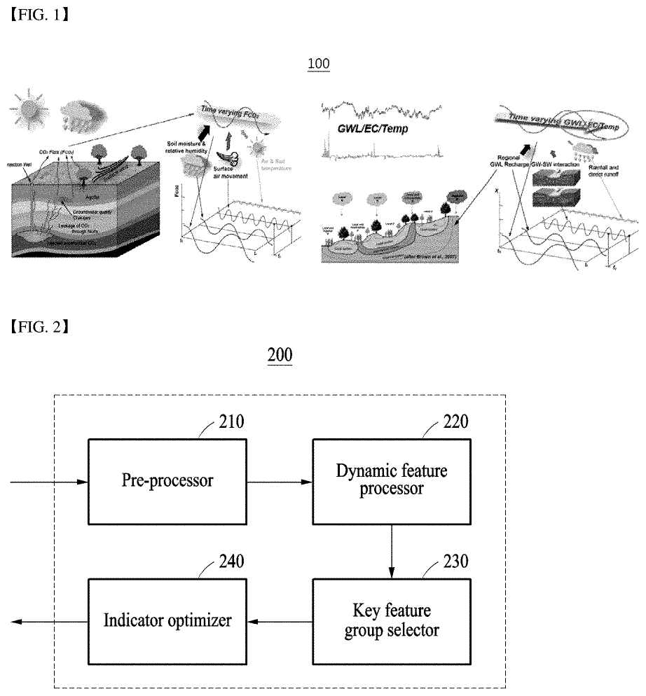

FIG. 1 is a diagram for explaining an application concept of a training indicator optimization apparatus for optimizing training indicators of an environmental prediction model according to an embodiment.

Referring to FIG. 1, reference 100 illustrates the apparatus for optimizing training indicators of an environmental prediction model according to an embodiment. Here, the environmental prediction model may be a multi-resolution long-short term neural network (MR-LSTM).

According to reference 100, the training indicator optimization apparatus according to an embodiment may more systematically separate and identify key environmental drivers, which cause changes in observed values, and effects thereof, using a multi-resolution time-frequency domain analysis method, with regard to environmental measurement data and environmental variable measurement data measured in real time and may perform quantitative evaluation of contribution.

In addition, the training indicator optimization apparatus may construct an LSTM deep learning neural network simultaneously using actual observations and environmental factors, inherent in the observations, based on the quantitative evaluation.

In addition, the training indicator optimization apparatus provides a basis for quantitative interpretation of the causality of selection and prediction of feature values for optimal learning and enables more intensive learning on the temporal-spatial variation characteristics of environmental measurement data and key environmental factors that are the targets of evaluation and prediction. Accordingly, when optimal training conditions are selected in advance or improved afterward, it may be expected to shorten a training time and improve the suitability and predictive ability of a model.

In addition, the training indicator optimization apparatus may be universally utilized for separation, identification, evaluation and prediction of various target variables measured in real time without being bound by the types of specific environmental measurement data and in particular, may greatly contribute to improving efficiency with regard to early identification and detection of dangerous signals in integrated environmental monitoring interpretation and a management system, vulnerability/risk assessment for specific-purpose environmental variables and complex environmental factors, and the implementation and operation of a real-time response system based on the assessment.

For example, environmental measurement data and environmental variable measurement data may include hydrological-environmental time series data (hydro-meteorological data, river and groundwater level, water quality, temperature, EC data (soil/stream water/groundwater electrical conductivity data), isotope ratio), soil gas data (CO₂, NO₂, CO, NO, SO₂, Rn) and fine dust data (PM10, PM2.5).

Specifically, the training indicator optimization apparatus may secure the structural features of environmental measurement data and environmental variable measurement data and a basis for causality therebetween through a dimensionality reduction model (e.g., multi-resolution state-space model).

For reference, general factor analysis corresponding to multivariate data corresponds to a quantification technique for major factors through dimensionality reduction of multivariate data. In addition, dynamic factor analysis among state-space models may extract and analyze common factors inherent in observation data through combination of time series analysis and factor analysis. In addition, time series analysis is a generic term for stochastic analysis techniques for data continuously observed in time order, and can be interpreted as a common noun applied to a wide range of fields.

Meanwhile, the training indicator optimization apparatus according to an embodiment may specifically identify environmental driving force and quantitatively evaluate influence by quantifying similarity between the potential driving force and a time-frequency domain of observed data through wavelet analysis-based multi-resolution correlation analysis.

For example, an observation of wavelet analysis may be calculated by a wavelet-filtered observation function derived through Equations 1 to 4 below:

$${ψ}_{a , b} ( t ) = {a}^{- \frac{1}{2}} ψ ( \frac{t - b}{a} ) \qquad [ Equation 1 ]$$

where Ψ denotes a wavelet mother function, a denotes a scale coefficient, b denotes a translation coefficient, a scale coefficient is a coefficient having a size of a represent period, and a transformation coefficient is a coefficient corresponding to a movement position on a time axis.

$$f ( t ) = {\overbrace{{\sum }_{j , k ϵZ} {C}_{j , k} {Ψ}_{j , k} ( t )}}^{CWT} \approx {\overbrace{{\underbrace{{\sum }_{j ϵ Z} {C}_{0 , j} {Ψ}_{0 , j} ( t )}}_{Approximations} + {\underbrace{{\sum }_{k \geq 0} {\sum }_{j ϵ Z} {d}_{k , j} {Φ}_{k , j} ( t )}}_{Details}}}^{DWT ( dyadic )} \qquad [ Equation 2 ]$$

where Ψ is a scaling function corresponding to a long scale and a low frequency, and Φ is a wavelet function corresponding to a short scale and a high frequency.

$${f}_{i}^{w} ( t ) = {\sum }_{j = 1}^{k} {α}_{i , j} {F}_{j} ( t ) + {μ}_{i} ( t ) + {ε}_{i} ( t ) \qquad [ Equation 3 ]$$

where fᵢ^{w}(t) is an i-th wavelet filtered observation (1≤i≤t), Fⱼ(t) is a j-th latent common factor (1≤j≤k), α_{i,j} is a dynamic factor loading, μᵢ(t) is an i-th constant level parameter (constant level parameter), and εᵢ(t) is a specific factor corresponding to a residual term.

$${F}_{j} ( t ) = {\sum }_{p = 1}^{n} {F}_{j} ( t - p ) + {η}_{j} ( t ) \qquad [ Equation 4 ]$$

where Fⱼ(t) is a j-th latent common factor, p is an optimal autoregressive order, and ηⱼ(t) is white noise.

Wavelet analysis as used herein may be interpreted as a multi-resolution analysis technique in a time-frequency domain using wavelet transform of time series data. Wavelet analysis is specialized in decomposing observation data into various time-frequency domains. In other words, wavelet analysis, which is one of methods of simultaneously analyzing a time domain and a frequency domain, may be applied to both continuous and discrete signals and may be widely applied to fault diagnosis.

Fast Fourier transform (FFT) has a disadvantage in that information in a time interval is lost because information in measurement data is averaged over time. Accordingly, wavelet transform is particularly useful for the analysis of a non-stationary signal or transient signal in which a defect frequency with respect to time changes. While general short-time Fourier transform (STFT) or Gabor transform uses a fixed filter window function of a new size to replace the problem limited to only a single frequency band, wavelet transform variably uses a narrow window function in a high frequency band and a wide window function in a low frequency band. Therefore, wavelet transform is also called constant relative bandwidth analysis, and has a characteristic that a change width of a frequency band is always proportional to a frequency value.

The training indicator optimization apparatus according to an embodiment considers changes occurring in time series with respect to each numerical value constituting environmental measurement data based on wavelet analysis. Therefore, the training indicator optimization apparatus may analyze a time domain and a frequency domain at the same time, and may monitor both a continuous signal and a discrete signal.

In addition, the training indicator optimization apparatus according to an embodiment may select a key features group, and may utilize the selected key feature group and environmental measurement data as inputs to more intensively learning key spatiotemporal features of the environmental measurement data, thereby being capable of continuously improving the predictive power of observations and factors.

That is, the training indicator optimization apparatus according to an embodiment may build a deep neural network learning model that utilizes a key feature group and environmental measurement data as inputs to intensively learn a key spatial and temporal change characteristic of a natural background change of the environmental measurement data, thereby being capable of continuously improving the predictive ability of observations and factors.

In conclusion, by using the present invention, major driving forces of river water, groundwater level and EC (RWL, GWL, RWEC, GWEC), soil gas concentration and flux (CO₂, FCO₂, CH₄, C₂H₆) observed in relation to a hydro-environmental cycle may be identified and evaluate contribution, the predictive power regarding RWL/RWEC/GWL/GWEC/CO₂/FCO₂/CH₄/C₂H₆ may be improved through a deep learning prediction model using a long-short term memory network (LSTM) that uses observation data and major environmental driving forces as input data, and a basis for interpretation of the causality of hyperparameter selection, which is one of the biggest difficulties of the ANN model, and the nonlinearity of training weight estimation may be presented.

As a more specific example, the present invention may identify the main driving force of groundwater level fluctuations and evaluate the contribution using one-unit river water level, groundwater level, and rainfall data measured for a preset period, and may identify the main driving force of indicator CO₂ flux using 6-hour hydrometeorological variables (rainfall, atmospheric temperature, relative humidity, insolation, wind speed) measured for 107 days, soil characteristic variables (soil moisture, soil electrical conductivity, soil temperature) according to depth and soil respiration parameters (CO₂ concentration, CO₂ flux, moisture content) and quantitatively evaluate contributions. The configuration of the training indicator optimization apparatus according to an embodiment is described in more detail with reference to FIG. 2.

FIG. 2 is a diagram for explaining the configuration of a training indicator optimization apparatus according to an embodiment.

In other words, FIG. 2 illustrates an embodiment of the training indicator optimization apparatus according to an embodiment described with reference to FIG. 1. In describing with reference to FIG. 2, contents overlapping with the description of the training indicator optimization apparatus according to an embodiment are omitted.

Referring to FIG. 2, a training indicator optimization apparatus 200 according to an embodiment may previously determine optimal training conditions according to data features and modeling purposes.

In addition, the training indicator optimization apparatus 200 may previously determine optimal training conditions, thereby preventing training time reduction and intensive learning and overfitting on key features, even for general LSTM models.

In addition, the training indicator optimization apparatus 200 may further improve predictive ability through real-time model update on input data even for general LSTM models by previously determining optimal training conditions and, at the same time, may provide a more efficient environmental prediction model for the establishment of an integrated environmental monitoring, interpretation, prediction and response system using various environmental data by presenting a quantitative basis for selecting an optimal training indicator.

That is, the training indicator optimization apparatus 200 according to an embodiment may set a pre-training optimization condition (training indicator optimization) that is a common limitation of deep learning techniques related to an existing LSTM mode, and may present a quantitative basis for determining the causality of a setting reason and post-training predictive ability.

For this, the training indicator optimization apparatus 200 may include a pre-processor 210, a dynamic feature processor 220, a key feature group selector 230 and an indicator optimizer 240.

The pre-processor 210 according to an embodiment may construct a base dataset for environmental measurement data.

In accordance with an aspect, the environmental measurement data may include hydrological-environmental time series data measured in real time. The hydrological-environmental time series data may include at least one environmental data of hydrometeorological data, river water level data, groundwater level data, water quality data, temperature data, EC data, isotope ratio data, soil gas data and fine dust data.

In accordance with an aspect, the pre-processor 210 may configure and arrange a data matrix according to observation items and observation time resolution of a dataset of the environmental measurement data as the base dataset, may interpolate missing data for each time domain resolution or time observation interval for the arranged base dataset, may noise-filter data of the interpolated base dataset, and may standardize and normalize the noise-filtered results.

For example, the pre-processor 10 may configure and arrange a panel matrix through readjustment of observation items and observation time resolution (scale) of a base dataset, which is a complex environmental time series measurement dataset, and through readjustment of variable items according to a target period. The arranged matrix may be interpreted as a base dataset.

For example, the scale may mean time domain resolution, and the time domain resolution may mean each of a plurality of domains formed by dividing a time domain of time series measurement data by a preset period.

In addition, the missing data may be interpreted as an element in which data corresponding to a record does not exist or there is no data for a record.

In addition, the pre-processor 210 may perform noise filtering using a Fourier/wavelet-based multi-resolution filter bank.

Meanwhile, the pre-processor 210 may standardize and normalize the noise-filtered result through a known standardization and normalization technique.

The dynamic feature processor 220 according to an embodiment may identify and extract dynamic characteristics of a base dataset constructed through multi-resolution wavelet analysis and a dimensionality reduction technique.

In accordance with an aspect, the dynamic feature processor 220 may derive wavelet energy distribution data on a time-frequency domain through the multi-resolution wavelet analysis according to a time domain resolution for the constructed base dataset and may select potential environmental drivers (PEDs) by applying the dimensionality reduction technique to the derived wavelet energy distribution data.

For example, PEDs may mean candidates that may be driving forces of data actually observed and analyzed, among a plurality of driving forces.

As a more specific example, PEDs may be interpreted as an environmental cause that causes changes in the main target observation and, when environmental measurement data is soil gas, may be interpreted as a cause that causes the concentration/flux of soil gas and changes in the time-varying characteristics/spatiotemporal characteristics thereof.

In other words, the dynamic feature processor 220 may derive a wavelet energy distribution in the time-frequency domain based on the multi-resolution spectral analysis according to the time domain resolution of the base dataset received through the pre-processor 210.

For example, the dimensionality reduction technique may include at least one technique of principal/independent component analysis (PCA/ICA), time series factor analysis (TSFA), empirical mode decomposition (EMD) and multi-resolution state-space model (MRSSM).

That is, the dynamic feature processor 220 may select candidate models for extracting the optimal potential environmental driving force through the above-described dimensionality reduction technique and may select main PEDs respectively corresponding to the selected candidate models.

In accordance with an aspect, the dynamic feature processor 220 may extract variation features according to a time change for each time domain resolution of the selected PEDs and may extract and quantify the dynamic features based on the extracted variation features.

The key feature group selector 230 according to an embodiment may identify and evaluate the driving force for environmental measurement data based on the extracted dynamic features and may select a key feature group in response to the evaluation result.

For example, the driving force for environmental measurement data may mean a general noun indicating a complex environmental factor that dominates the fluctuation of actual environmental measurement data.

In accordance with an aspect, the key feature group selector 230 may determine a multi-resolution correlation between the potential environmental driving force of the PEDs and the environmental measurement data. In this case, the key feature group selector 230 may perform correlation determination that reflects time delay and phase change between the potential environmental driving force and the observed data and may select a maximum correlation scale between the potential environmental driving force and the observed data based on the performed correlation determination result.

For example, the maximum correlation scale may be a time-frequency band of a maximum correlation based on a multi-resolution correlation and cross-correlation between the potential driving force and observed data, and the maximum correlation may mean a result having the highest correlation among a plurality of result values derived through analysis of multi-resolution correlation and cross-correlation.

In accordance with an aspect, the key feature group selector 230 may identify driving force using a correlation between a wavelet energy ratio between the potential environmental driving force and the observed data and the selected maximum correlation scale, may evaluate relative contribution by processing linear coupling between a binding energy ratio of the selected maximum correlation scale and an explanatory power index of a dimensionality reduction model, and may select the key feature group based on the evaluated relative contribution.

In other words, the key feature group selector 230 may select (key)driving force by identifying PEDs through multi-resolution time-frequency correlation/cross correlation diagnosis.

For example, the relative contribution may be evaluated based on the effective dynamic efficiency (t, D_{ef}) through linear coupling between the binding energy ratio of the maximum correlation scale and driving force selection indicators (factor loading or correlations) of optimal potential environmental driving force selection models. Here, t denotes a maximum correlation scale (cycle) and D_{ef} denotes a contribution ratio (%).

Preferably, a contribution ratio may be derived through Equation 5 below:

D_{ef}(%)=α×E_{c}×100 [Equation 5]

where α denotes a dynamic factor loading, and E_{c} denotes a binding energy ratio of a maximum correlation scale.

That is, the evaluated relative contribution may be used to determine by what factor a sudden change in a base dataset occurs, and may support to provide an optimal response scenario to a phenomenon that has occurred based on the identified and evaluated driving force.

In other words, the key feature group selector 230 may select a key feature group for each target variable for selecting optimal LSTM training indicators based on effective dynamic efficiency (t, D_{ef}).

In accordance with an aspect, the key feature group selector 230 may build a pre-tuned LSTM network (well-tuned LSTM networks) that is trained using at least one of the PEDs and the key feature group, and may verify the potential environmental driving force using the pre-tuned LSTM network.

For example, the pre-tuned LSTM network may be an LSTM network including PEDs as a candidate group for selecting an optimal training condition.

In conclusion, the structural features of various environmental factors that change over time may be reflected in environmental measurement data based on time series data by using the training indicator optimization apparatus 200 according to an embodiment. In addition, key environmental drivers that cause changes in observed values and effects thereof may be more systematically separated and identified by using a multi-resolution time-frequency domain analysis method.

The indicator optimizer 240 according to an embodiment may receive the selected key feature group and the environmental measurement data as inputs and may control a plurality of training indicators corresponding to an environmental prediction model.

For example, the plural training indicators may include at least one of a training period (T), a minibatch size (mbs), the number of hidden layers (HL) and the number of optimal epochs (E). Here, a batch size may mean the size of a training interval used for one training (1 epoch).

In accordance with an aspect, the indicator optimizer 240 may build a long-short term memory network model using the key feature group and the environmental measurement data as inputs and may priorly-quantify the plural training indicators based on a time-frequency domain of the key feature group.

For example, the built long-short term memory network model may be a network that is built, further improved, selected and strengthened through more intensive learning in the highest correlation frequency band using the identified key driving force.

In other words, the indicator optimizer 240 may pre-quantify a plurality of training indicators based on the highest correlation frequency band of the maximum correlation scale.

Here, since the maximum correlation scale is determined by a frequency band, not by a single frequency, the long-short term memory network model built by specifying a frequency band (e.g., D1 to D3) and combining various training indicators may be updated.

In accordance with an aspect, the indicator optimizer 240 may select at least one predictive model based on residual verification, based on complex model verification indicators of observations measured from the environmental measurement data and values predicted from the long-short term memory network model, and multi-resolution analysis of the residuals, and may quantify the plural pre-quantified training indicators based on one predictive model of the selected predictive models or a combined prediction model of two or more predictive models of the selected predictive models.

For example, the predictive model selected based on the multi-resolution analysis may mean environment prediction models corresponding to various scenarios in a scenario-based environment response system. That is, the predictive model selected based on the multi-resolution analysis may be an environmental prediction model for integrated environmental monitoring and response system implementation.

In accordance with an aspect, the indicator optimizer 240 may select an optimal predictive model based on the optimal training indicators by performing residual verification and multi-resolution analysis of the residuals based on at least one complex model verification indicator of AICc×BIC, RMSE (root mean squared error)×MAPE (maximum absolute percentage error) and linearity representative index (R² or adjusted R²).

As a more specific example, the indicator optimizer 240 may enable the complex model verification indicator (Combined Index (CI), AICc×BIC or RMSE×MAPE) for determining the accuracy of the predictive model to select predictive models representing the best performance (minimum value in the case of AICc×BIC and RMSE×MAPE).

That is, since there are cases where a single predictive model shows the best performance and there are cases where a combined prediction model of a plurality of predictive models shows the best performance, the indicator optimizer 240 may select the best performance predictive model (single or combined prediction model) according to data features and may consider a plurality of training indicators of the selected model as optimal training indicators.

In accordance with an aspect, the indicator optimizer 240 may construct an optimal training indicator model (e.g., generalized linear function model or regression model) using at least two training indicators of the plural quantified training indicators.

For example, the optimal training indicator model may be a model representing a (linear) regression-type relationship between the number of hidden layers (HL), the number of epochs (epoch, E), a minibatch size (mbs), and a training period (T) which are a plurality of training indicators.

As a more specific example, the optimal training indicator model may be a model expressed in the same form as a 90% training interval of daily average data JDEC of stream water EC (JDEC) with a length of 1095, and Op_JDEC=Xmbs\hat{ }k+YE+z (where mbs denotes a minibatch size, E denotes epochs, and k, X,Y, and z denote estimated parameters) as an optimal training condition (Op_JDEC) for hidden layer=200.

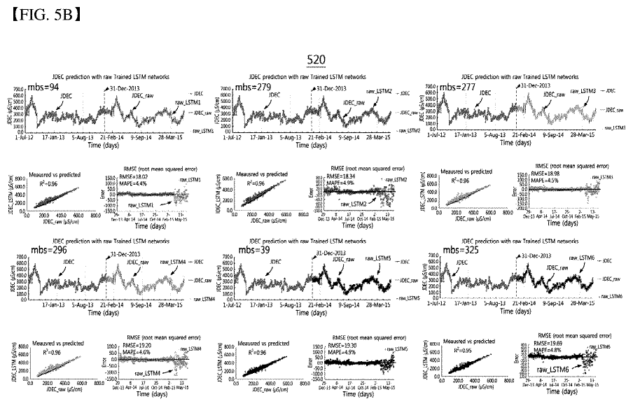

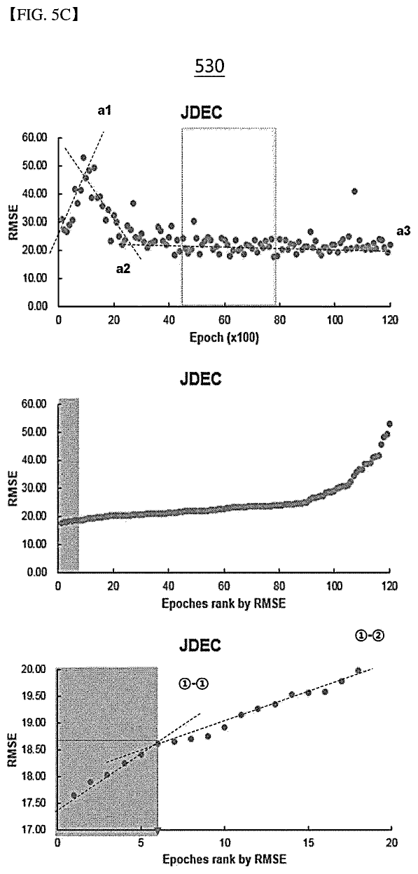

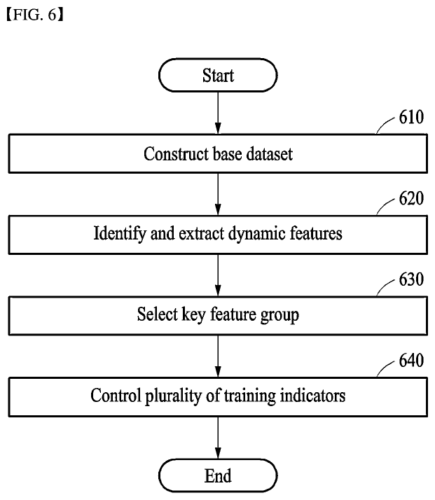

An embodiment of configuring the optimal training indicator model according to an embodiment is described in detail below with reference to FIGS. 5A to 5C.

In other words, the indicator optimizer 240 may apply at least two training indicators of the quantified training indicators to an environmental prediction model to previously determine optimal training conditions, thereby reducing training time and preventing intensive learning and overfitting on key features, even for general LSTM models.

In addition, the indicator optimizer 240 may further improve predictive ability through real-time model update on input data even for general LSTM models by previously determining optimal training conditions and, at the same time, may provide a more efficient environmental prediction model for the establishment of an integrated environmental monitoring, interpretation, prediction and response system using various environmental data by presenting a quantitative basis for selecting an optimal training indicator.

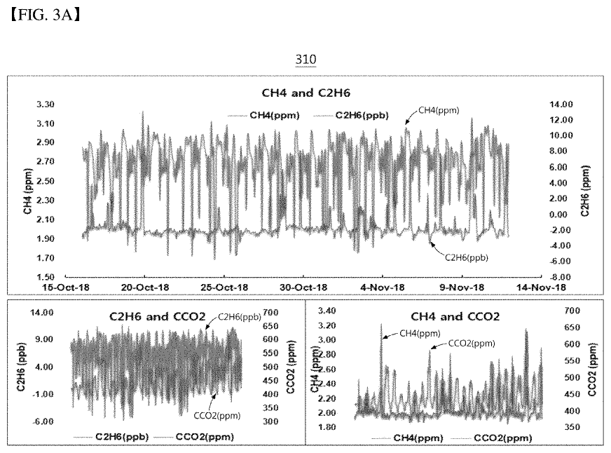

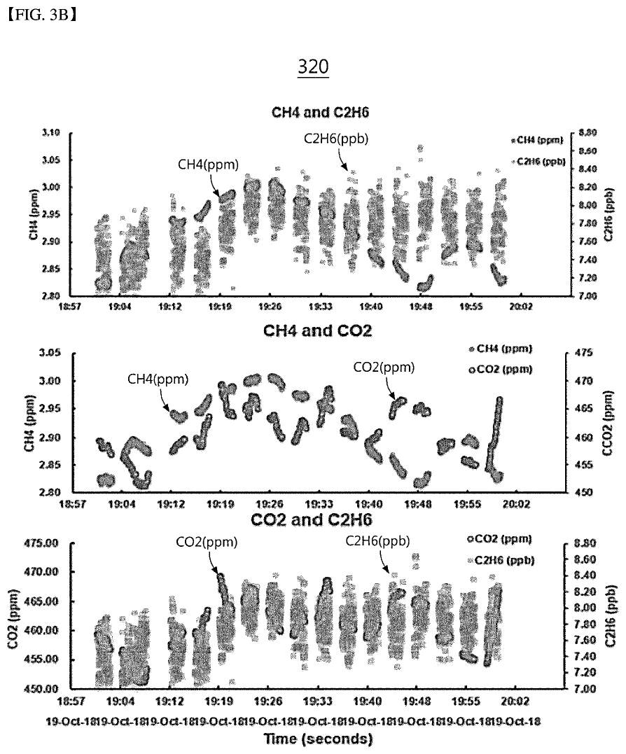

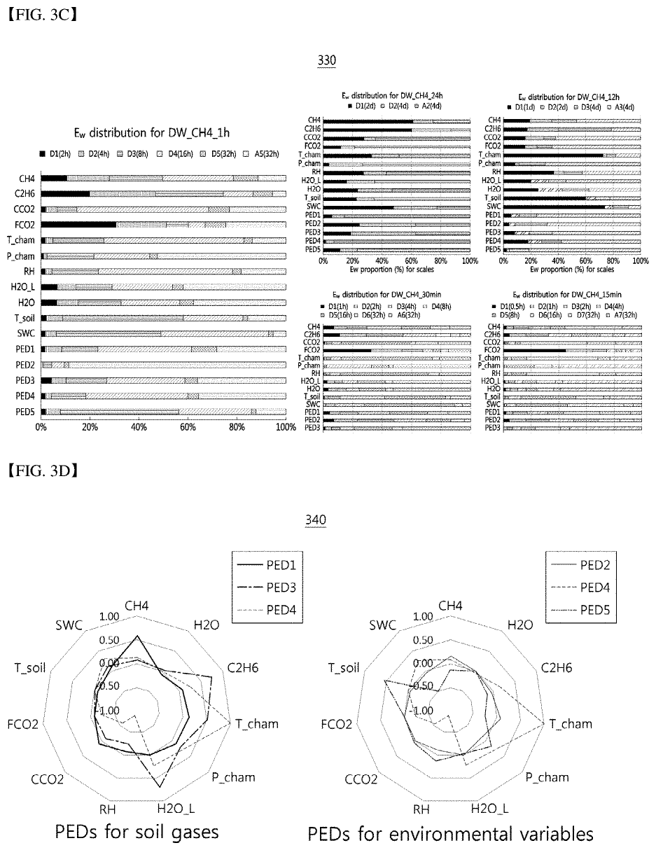

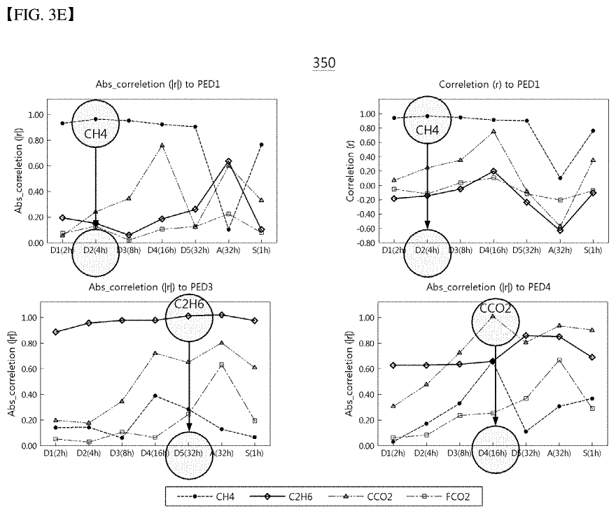

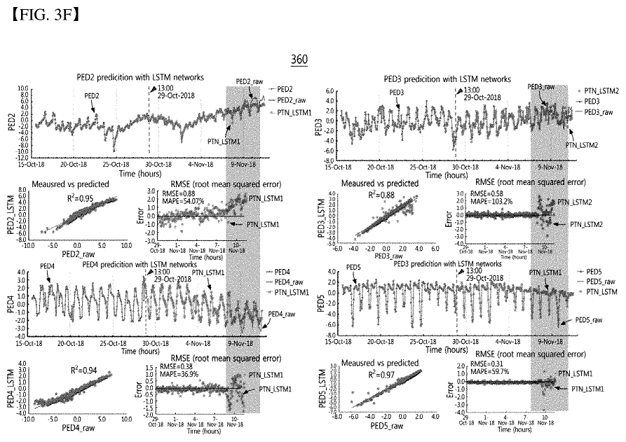

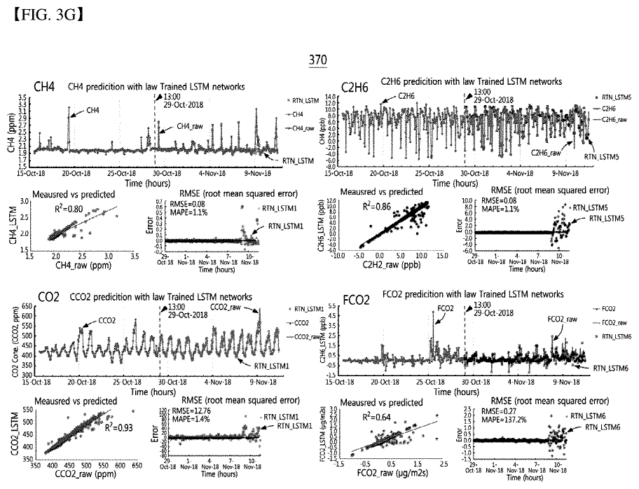

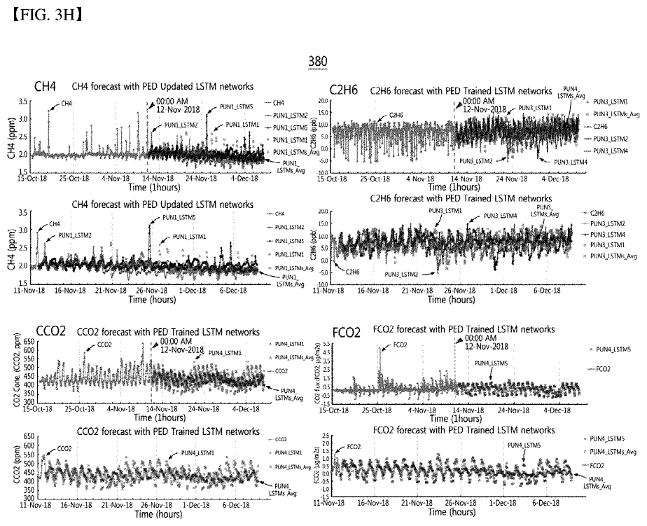

FIGS. 3A to 3H are diagrams for explaining an embodiment of an operation of receiving soil gas as environmental measurement data by a training indicator optimization apparatus according to an embodiment.

In other words, FIGS. 3A to 3H illustrate an operation example of the training indicator optimization apparatus according to an embodiment described above with reference to FIGS. 1 and 2. Accordingly, in describing with reference to FIGS. 3A to 3H, contents overlapping with the contents of the training indicator optimization apparatus according to an embodiment are omitted.

Referring to FIGS. 3A to 3H, reference 310 illustrates a change in soil gas measurement data according to time change in a preset time unit, and reference 320 illustrates a change in soil gas measurement data according to time change in a second unit.

In addition, reference 330 illustrates wavelet energy distribution data for a time-frequency domain of soil gas measurement data, and reference 340 illustrates PEDs for soil gas measurement data.

In addition, reference 350 illustrates a correlation analysis result between PEDs and soil gas measurement data, reference 360 illustrates a prediction result of PEDs using a pre-tuned LSTM network (well-tuned LSTM networks), and reference 370 illustrates a prediction result of soil gas measurement data using a pre-tuned LSTM network.

In addition, reference 380 illustrates a forecast result of soil gas measurement data using the MR-LSTM model.

For reference, in references 310 to 380, CH4 denotes methane gas concentration, C2H6 denotes ethane gas concentration, CCO₂ denotes a carbon dioxide concentration, FCO₂ denotes CO₂ flux, T-cham denotes the air temperature in a chamber, P_cham denotes the atmospheric pressure in a chamber, RH denotes relative humidity, H2O denotes a soil surface moisture content, H2O_L denotes a moisture content in a chamber, T_soil denotes soil temperature, SWC denotes a soil volumetric water content, and PED1 to PED5 denote first to fifth PEDs.

Specifically, from references 310 to 320, t can be confirmed that it is difficult to derive a clear linear correlation between variables including CH4, C2H6 and CCO₂ in a change in soil gas measurement data according to time change, and a new approach based on delayed interdependence and non-linear response of field measurement data is required to derive a linear correlation.

In other words, since the single scale (time domain resolution)-based linear correlation is not effective in representing the dynamic features of complex and nonlinear soil gas, it is necessary to perform multi-scale correlation analysis based on a correlation according to a scale as in the training indicator optimization apparatus according to an embodiment.

As shown in reference 330, the training indicator optimization apparatus according to an embodiment may derive wavelet energy distribution data for a time-frequency domain with respect to soil gas measurement data.

More specifically, reference 330 illustrates wavelet energy distribution data for raw data of major observation variables related to soil gas measurement data, and D1 to D5 and A1 to A5 are wavelet decomposition steps by discrete wavelet analysis and represent the time-frequency scale of each component used for wavelet analysis over various ranges depending on the length of observation data.

In the environmental time series for wavelet energy distribution, PEDs may be decomposed into a final approximate component (A5) and detailed components (D1 to D5) using discrete wavelet transform (DWT).

Ap and Dp for a decomposition level among the items constituting the equation of the discrete wavelet transform (DWT) may be included. Ap and Dp can apply a low-frequency signal of 0.25 cycles or less and a high-frequency signal of 0.25 to 0.5 cycles at each resolution level (p). When considering a decomposition level according to the length of observation data, the maximum decomposition level A5 according to an embodiment corresponds to a scale of 32 hours, which may be variously selected according to an observation interval and length of raw data.

Thereafter, all time-frequency scales for the decomposition level according to an embodiment may be 2 hours (D1), 4 hours (D2), 8 hours (D3), 16 hours (D4), and 32 hours (D5).

As an example, the processes from D1 to D3 can be considered short-term (a scale of 8 hours) and processes of D5 and A5 may be considered as long-term (a scale of 32 hours or more) or seasonal.

As shown in reference 330, the training indicator optimization apparatus according to an embodiment may determine the influence of PEDs (PED1 to PED5) on complex environmental factors through wavelet energy distribution data analysis for the time-frequency domain.

According to reference 340, the training indicator optimization apparatus according to an embodiment may derive wavelet energy distribution data for the time-frequency domain through multi-resolution wavelet analysis and may select PEDs by applying a dimensionality reduction technique to the derived wavelet energy distribution data.

The PEDs selected by reference 340 may be expressed as shown in Table 1 below.

TABLE 1

| PEDs | Variables with loading | Environmental Meaning |
|---|---|---|
| 1 | CH4 (0.59), T_cham (0.12) | CH4 dynamics with |
| | | T_atm effect |
| 2 | P_cham (−0.11) | Air movement effect |
| 3 | C2H6 (0.74), RH (−0.26) | C2H6 dynamics with RH effect |
| 4 | T_cham (1.00), RH (−0.88), | CO₂ dynamics with |
| | C CO₂ (−0.59), F CO₂ (−0.25) | T_atm and RH effect |
| 5 | T_soil (0.58), SWC(−0.51) | Soil temperature and |
| | | moisture effect |

According to reference 350, the training indicator optimization apparatus according to an embodiment may determine a multi-resolution correlation between PEDs and the soil gas measurement data.

More specifically, the training indicator optimization apparatus according to an embodiment may consider scale versus correlation so as to determine which frequency among observed data is a key frequency.

For each element constituting the observation data, it is possible to determine which frequency is a key frequency by checking the correlation coefficient (r) against the scale. For example, when the correlation coefficient (r) for each discrete wavelet decomposition level is 0.5 or more, PED1 shows a high correlation coefficient on the scale of D2, PED3 shows a high correlation coefficient on the scale of D5, and PED4 shows a high correlation coefficient on the scale of D4.

That is, the training indicator optimization apparatus according to an embodiment may select a maximum correlation scale having the highest correlation by checking the wavelet energy distribution.

Meanwhile, the training indicator optimization apparatus according to an embodiment may evaluate a relative contribution by processing linear coupling between a binding energy ratio of the selected maximum correlation scale and an explanatory power index of an appropriate dimensionality reduction model (e.g., multi-resolution state-space model) and may select a key feature group based on the evaluated relative contribution.

In accordance with an aspect, the relative contribution may be evaluated based on effective dynamic efficiency (t, D_{ef}) through linear coupling between the binding energy ratio of the maximum correlation scale and driving force selection indicators (factor loading or correlations) of optimal potential environmental driving force selection models, and the evaluated relative contribution may be shown as in Table 2 below.

TABLE 2

| | | Potential | Main | Cumulative | DyF | |
|---|---|---|---|---|---|---|
| | Soil | Environmental | bands | energy | loading | Maximum |
| Time scales | gases | drivers (PEDs) | (Scales) | ratio (Ec) | (α) | D_{ef} (%) |
| DW_SGs_1 h | CH4 | Complex effect of | D1-D2 | 0.28 | 0.59 | 16.52% |
| | | CH4 emission & | (2-4 h) | | | |
| | | T_atm (PED1) | | | | |
| | C2H6 | RH effect (PED3) | D5-A5 | 0.13 | 0.74 | 9.62% |
| | | | (32 h) | | | |
| | C CO₂ | Complex effect of | D4 (16 h) | 0.54 | \|−0.59\| | 31.86% |
| | | CO₂ emission and | | | | |
| | | T_atm + RH (PED4) | | | | |
| | F CO₂ | Seasonality | D5-A5 | 0.33 | \|−0.25\| | 8.25% |
| | | | (32 h) | | | |

As shown in Table 2, PED4 and PED1 were evaluated to have the highest relative contribution, and the training indicator optimization apparatus according to an embodiment may select a key feature group based on the evaluated relative contribution.

According to references 360 to 380, it can be confirmed that the prediction and forecasting capabilities of the training indicator optimization apparatus according to an embodiment may be improved through enhanced focused learning based on the key features of the selected soil gas.

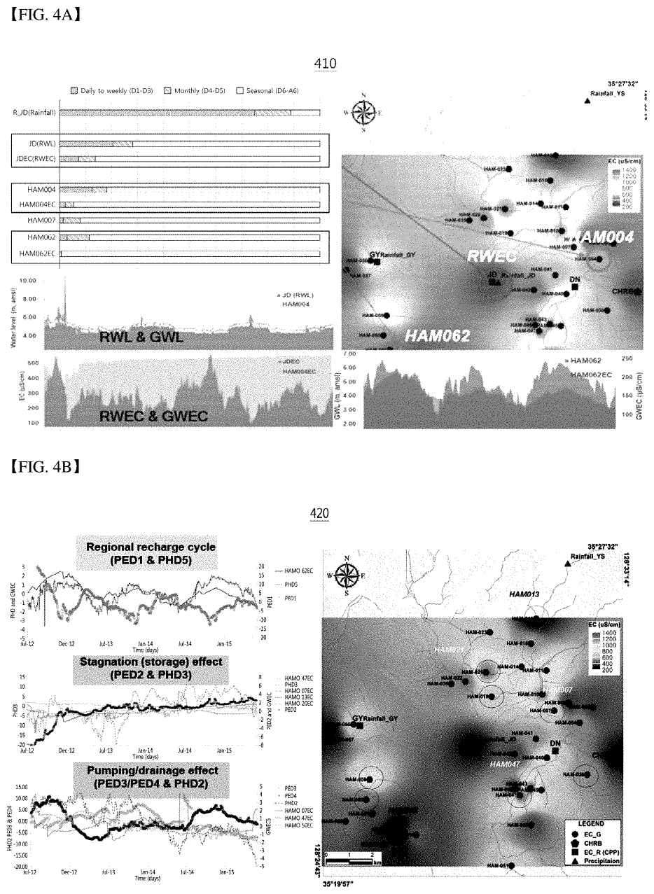

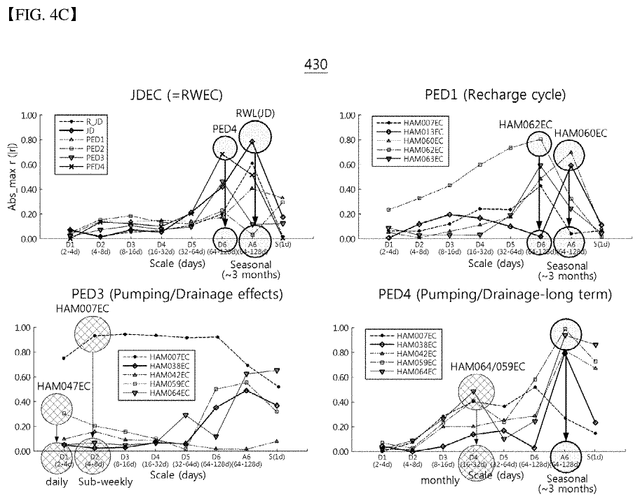

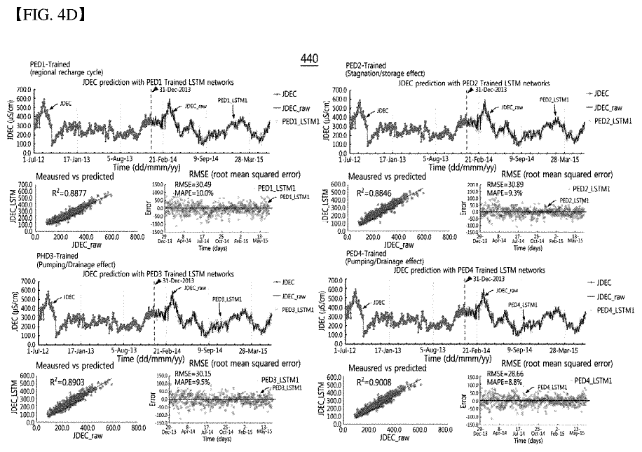

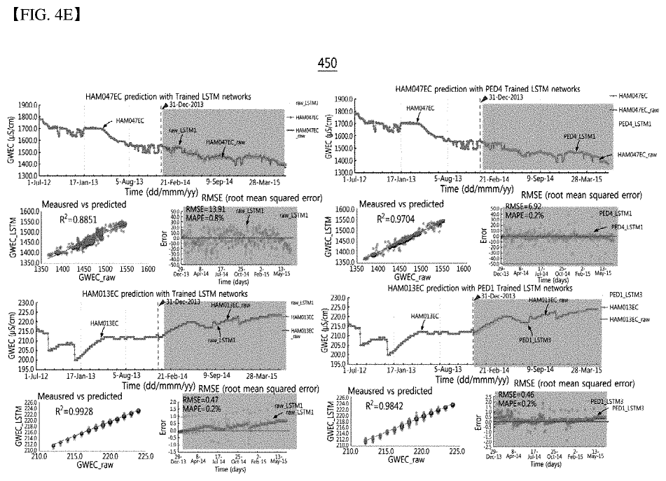

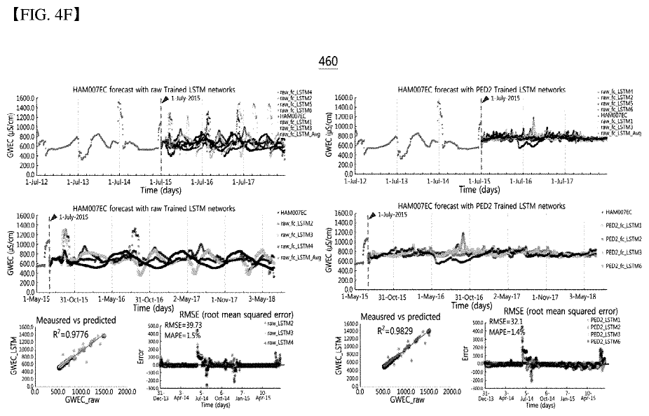

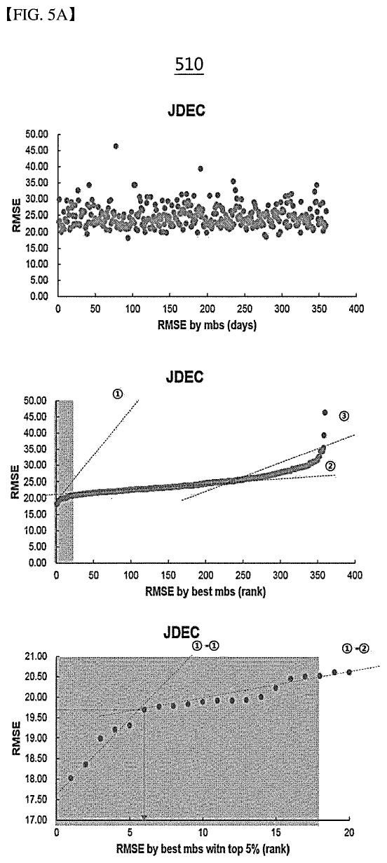

FIGS. 4A to 4F are drawings for explaining an embodiment of an operation of receiving river/groundwater level (RWL/GWL) and electrical conductivity (RWEC/GWEC) measurement data as environmental measurement data by a training indicator optimization apparatus according to an embodiment.

In other words, FIGS. 4A to 4F illustrate an operation example of the training indicator optimization apparatus according to an embodiment described above with reference to FIGS. 1 to 3H. In describing with reference to FIGS. 4A to 4F, contents overlapping with the contents of the training indicator optimization apparatus according to an embodiment are omitted.

Referring to FIGS. 4A to 4F, reference 410 shows wavelet energy distribution data for groundwater level (GWL)/electrical conductivity (EC), and reference 420 shows an example of selecting PEDs of groundwater-electrical conductivity (GWEC) measurement data using a multi-resolution state-space model (MRSSM).

In addition, reference 430 shows a correlation analysis result between PEDs and groundwater-electrical conductivity (GWEC) measurement data, and reference 440 shows an electrical conductivity (JDEC) prediction result of river water using a pre-tuned LSTM network (well-tuned LSTM networks).

In addition, reference 450 shows a prediction result of GWEC using a pre-tuned MR-LSTM network (well-tuned MR-LSTM networks), and reference 460 shows a forecast result of GWEC using a pre-tuned MR-LSTM network.

For reference, in references 410 to 460, EC denotes the electrical conductivity of groundwater/river water, GW denotes groundwater, JD denotes a river water level (RWL) station name, JDEC denotes the electrical conductivity (RWEC) of river water, Rainfall denotes cumulative rainfall, PED1 to PED4 denote first and second PEDs of electrical conductivity (EC), and PHD1 to PHDS denote first to second potential environmental driving force candidate groups of groundwater level (GWL).

Specifically, according to reference 410, it can be confirmed that GWL and GWEC have different patterns even in the same groundwater wells (GW wells), and the different patterns are easily identified and quantified through wavelet energy distribution data for the time-frequency domain.

Specifically, the lower-left drawing of reference 410 shows a river water level or river water EC, and groundwater level/EC, and the upper-left drawing of reference 410 shows a wavelet energy density graph. It can be confirmed that the groundwater level of a groundwater well (HAM004) adjacent to river observed in a lower-left part is almost the same as a change in the river water level (RWL=JD), but EC is shown a quite different pattern (see lower-left drawings RWEC & GWEC).

Therefore, by examining the wavelet energy distribution, the similarly observed groundwater level (HAM004) and river water level (JD) may be more clearly distinguished, and above all, the difference between the water level and the EC pattern may be expressed more clearly.

Based on this, it is possible to more quantitatively identify which frequency region well represents each water level and EC variability. Therefore, the highest correlation frequency band may be selected through wavelet energy distribution and comparison/contrast and correlation/cross-correlation analysis of potential driving force candidate groups.

For example, it can be confirmed that in the case of RWL (JD), variability of daily to monthly accounts for about 30%, whereas in RWEC, it is less than 15% (comparison of water level and EC for the same observation point), and HAM062EC, compared to HAM004EC, is dominated by long-period cyclic fluctuations (comparison of fluctuation features at different points for the same observation value (EC)).

In addition, it can be confirmed that in the case of RWEC (JDEC), short-period variability is more dominant overall, compared to GWEC (comparison of variability in different systems (river and groundwater) of the same observation data (EC)).

In conclusion according to reference 410, it can be confirmed that complex patterns that are similar or different from each other can be identified more clearly and quantitatively.

In addition, according to reference 420, the training indicator optimization apparatus according to an embodiment may derive wavelet energy distribution data on the time-frequency domain through multi-resolution wavelet analysis on GWEC measurement data, and may select PEDs by applying a dimensionality reduction technique to the derived wavelet energy distribution data.

In addition, according to reference 430, the training indicator optimization apparatus according to an embodiment may determine a multi-resolution correlation between PEDs and GWEC measurement data.

More specifically, the training indicator optimization apparatus according to an embodiment may consider a scale-versus-correlation so as to determine the key frequency among the observed data.

For each element constituting the observed data, it is possible to determine which frequency is a key frequency by checking a correlation coefficient (r) against the scale. For example, when the correlation coefficient (r) for each discrete wavelet decomposition level is 0.5 or more, HAM062EC of PED1 shows the highest correlation coefficient on the scale of D6, and HAM060EC shows the highest correlation coefficient on A6.

That is, the training indicator optimization apparatus according to an embodiment may select a maximum correlation scale having the highest correlation by checking the wavelet energy distribution.

According to references 440 to 460, it can be confirmed that the prediction and forecasting capabilities of the training indicator optimization apparatus according to an embodiment may be improved through enhanced focused learning based on the key features of the selected GWEC.

Specifically, the left drawing of reference 450 shows the output of a raw-trained LSTM (LSTM trained using only observed data), and the right drawing of reference 460 shows the output of PED trained LSTM (LSTM trained through potential driving force).

According to reference 50, it can be confirmed that in particular in the prediction of nonlinear data (e.g., when there is a downtrend as in HAM047EC, or when there is a sharp uptrend and uptrend as in HAM013EC), the model trained through PED exhibits prediction performance superior to that of the model trained using only observed data.

The left drawing of reference 460 shows an example of future forecast of LSTM (raw LSTM) trained only with observed data on nonlinear data (HAM007EC), and the right drawing of reference 460 shows an example of future forecast of LSTM (PED-LSTM) trained based on potential driving force on nonlinear data (HAM007EC).

According to reference 460, it can be confirmed that in the case of data showing rapid transient variation as in HAM007EC of the left drawing of reference 460, the future prediction (forecast) value of the model (raw-LSTM) trained only with observations is very unstable and therefore unreliable in many cases.

On the other hand, it can be confirmed that the model trained through PED (PED-LSTM) in the right drawing of reference 460 shows more stable and convincing future forecast values compared to the raw-LSTM, especially in the forecast of observations including non-linear and transient fluctuations.

More specifically, since environmental data observed at the field scale, such as groundwater level, EC, soil gas concentration and flux, including nonlinear and transient measurements due to the complex effects of various cycles of the hydrologic processes and anthropogenic factors, and the nonlinear and transient measurements represent the dynamic response of the environmental system to the applied environmental impacts, the most important dynamic response information may be lost when the nonlinear and transient measurements are treated as outliers or removed to satisfy a stationary assumption.

Accordingly, the LSTM trained through PED may be an alternative that can properly harmonize the features of the nonlinear and transient signals with the stability of the predictive model and, in particular, it is possible to build a real-time integrated environmental monitoring and response system based on various future scenarios by using raw-LSTM and PED-LSTM together.

For example, when it is assumed that the GWEC follows Model No. 2 (LSTM2) (Scenario No. 2), a threshold value (e.g., based on 26 range) may be selected through comparison of the future forecast values of raw-LSTM2 (left) and PED2-LSTM2 (right, the 2nd scenario of LSTM trained with PED2), or an early alarm compared to a preset threshold value may be issued (4F left raw-LSTM2 standard, 1 Jul. 2015).

On the other hand, when based on the scenario of PED2-LSTM2 on the right, the early warning on the left may be judged as a false alarm, and it may be assumed that an actual alarm takes effect on 1 Sep. 2016 (4F right PED2-LSTM2 standard). FIGS. 5A to 5C illustrate an example of configuring an optimal training indicator model according to an embodiment.

In other words, FIGS. 5A to 5C illustrate an example of constructing an optimal training indicator model by the training indicator optimization apparatus according to an embodiment described above with reference to FIGS. 1 to 4F. Accordingly, in describing with reference to FIGS. 5A to C, contents overlapping with the contents of the training indicator optimization apparatus according to an embodiment are omitted.

Referring to FIGS. 5A to 5C, references 510 to 530 illustrate an example of constructing an optimal training indicator model using the minibatch size (mbs) and/or the number of optimal epochs (E) which are calculated through analysis of river water EC (RWEC=JDEC) data.

Specifically, reference 510 shows an example of selecting an optimal mbs (best mini-batch size) model based on rules-of-thumb analysis of RMSE (root mean squared error) on river water EC (JDEC) data, and reference 520 shows an example of determining an optimal training indicator model through the top 6 mbs models for river water EC (JDEC) data.

In addition, reference 530 illustrates an example of selecting an optimal epoch model based on rules-of-thumb analysis of RMSE for river water EC (JDEC) data.

Meanwhile, in references 510 to 530, dotted regression lines and numbers (\textcircled{1} to \textcircled{3}, a1 to a3) are provided to more specifically explain an application example of the rules of thumb so as to identify a major elbow point of the RMSE change (trend).

Specifically, the first drawing of reference 510 shows a change (HL=200, E=1500) in RMSE for each mbs from 1 to 360 (1, 2, 3, . . . , 360), and the second drawing shows an RMSE change according to the mbs (1 to 360) per rank (smaller value priority) based on RMSE. Here, the main RMSE elbow points may be divided into top 5% in number \textcircled{1}, top 5% to 60% in number \textcircled{2}, and top 60% to 100% in number \textcircled{3}.

In addition, the third drawing of reference 510 shows an example of re-dividing the top 5% into \textcircled{1}-\textcircled{1} (Ranks 1 to 6) and \textcircled{1}-\textcircled{2} (Ranks 7 to 18) which are optimal mbs intervals based on the main RMSE elbow point and selecting the models corresponding to Rank1—Rank6 as optimal mbs models.

Meanwhile, in reference 530, the first drawing shows an RMSE change for each E (epochs: 100, 200, 300, . . . , 12000) from 1 to 120, elbow points (a1 to a3) of optimal RMSE regression lines, and an epoch (E) section (a dotted line box of reference 530) in which optimal RMSE (i e , minimum RMSE) is shown, the second drawing shows RMSE changes according to the epochs (E) (100 to 12000) by rank (smaller value first) based on RMSE (where the pink box is the top 5%), and the third drawing shows the main elbow point of the RMSE regression line for each epoch (E) according to the RMSE ranking of the top 5% (\textcircled{1}-\textcircled{1}) and the top 5-15% (\textcircled{1}-\textcircled{2}) and an example of the optimal epoch (E) selection method (rules of thumb).

According to references 510 to 520, the river water EC (JDEC) data analysis result illustrated in reference 510 may be expressed as in Table 3 below, and the analysis results of the top six mbs models shown in reference 520 may be expressed as in Table 4 below.

TABLE 3

| | mbs | Cycle | |
|---|---|---|---|
| Rank | (days) | (months) | RMSE |
| 1 | 94 | 3.1 | 18.02 |
| 2 | 279 | 9.3 | 18.36 |
| 3 | 277 | 9.2 | 18.98 |
| 4 | 296 | 9.9 | 19.20 |
| 5 | 39 | 1.3 | 19.30 |
| 6 | 325 | 10.8 | 19.69 |
| 7 | 146 | 4.9 | 19.77 |
| 8 | 199 | 6.6 | 19.78 |
| 9 | 187 | 6.2 | 19.82 |
| 10 | 5 | 0.2 | 19.88 |
| 11 | 298 | 9.9 | 19.90 |
| 12 | 141 | 4.7 | 19.91 |
| 13 | 139 | 4.6 | 19.92 |
| 14 | 117 | 3.9 | 19.99 |
| 15 | 356 | 11.9 | 20.21 |
| 16 | 107 | 3.6 | 20.43 |
| 17 | 342 | 11.4 | 20.49 |
| 18 | 70 | 2.3 | 20.51 |

TABLE 4

| LSTM_rank | LSTM1 | LSTM2 | LSTM3 | LSTM4 | LSTM5 | LSTM6 | LSTM_avg |
|---|---|---|---|---|---|---|---|
| mbs (days) | 94 | 279 | 277 | 296 | 39 | 325 | 218.3 |
| RMSE | 18.02 | 18.36 | 18.98 | 19.20 | 19.30 | 19.69 | 15.74 |
| MAPE (%) | 4.4% | 4.9% | 4.5% | 4.6% | 4.8% | 4.8% | 4.0% |
| Combined | 0.793 | 0.903 | 0.846 | 0.883 | 0.936 | 0.953 | 0.622 |
| Index (CI, | | | | | | | |
| RMSE × | | | | | | | |
| MAPE) | | | | | | | |
| Rank_by_CI | 1 | 4 | 2 | 3 | 5 | 6 | — |

According to Tables 3 and 4, the training indicator optimization apparatus according to an embodiment may select the top 6 mbs models (Ranks 1 to 6 of Table 1) as the top 5% based on the rules-of-thumb analysis of RMSE in the river water EC (JDEC) data shown in reference 510. Here, the hidden layers (HL) may be 200, epochs (E) may be 1500, a training period (T) may be 953 days, and mbs may be a range in which 1 to 360 are sequentially progressed by one section. Here, HL means the number of hidden layers.

In addition, the training indicator optimization apparatus may perform a correlation with a maximum correlation scale (Ec) through wavelet energy (Ew) distribution re-diagnosis between JDEC and PEDs, and through this, may present the basis for selecting an optimal mbs model.

In accordance with an aspect, the training indicator optimization apparatus may select an optimal mbs model through retraining and refitting. For example, the training indicator optimization apparatus may calculate an optimal mbs model through retraining and refitting for a range of 270 to 300 mbs.

Meanwhile, the training indicator optimization apparatus may construct an optimal training indicator model using optimal mbs training conditions based on a combined index (CI, RMSE×MAPE) for the predicted values (predictions) of the top 6 mbs models.

According to reference 530, the analysis results of the river water EC (JDEC) data shown in reference 530 may be expressed as in Table 5 below.

TABLE 5

| | mbs | cycle | | |
|---|---|---|---|---|
| Rank | (days) | (months) | epochs | RMSE |
| 1 | 256 | 8.5 | 7800 | 17.64 |
| 2 | 256 | 8.5 | 6200 | 17.90 |
| 3 | 256 | 8.5 | 7900 | 18.03 |
| 4 | 256 | 8.5 | 4200 | 18.25 |
| 5 | 256 | 8.5 | 9500 | 18.41 |
| 6 | 256 | 8.5 | 5800 | 18.61 |
| 7 | 256 | 8.5 | 5100 | 18.65 |
| 8 | 256 | 8.5 | 8600 | 18.70 |
| 9 | 256 | 8.5 | 6700 | 18.74 |
| 10 | 256 | 8.5 | 4700 | 18.90 |
| 11 | 256 | 8.5 | 10100 | 19.14 |
| 12 | 256 | 8.5 | 7200 | 19.26 |
| 13 | 256 | 8.5 | 11900 | 19.35 |
| 14 | 256 | 8.5 | 9400 | 19.53 |
| 15 | 256 | 8.5 | 9800 | 19.55 |
| 16 | 256 | 8.5 | 4400 | 19.57 |
| 17 | 256 | 8.5 | 6300 | 19.77 |
| 18 | 256 | 8.5 | 6500 | 19.98 |

According to Table 5, the training indicator optimization apparatus according to an embodiment may select 6 mbs models (Ranks 1 to 6 of Table 3) as the top 5% based on the rules-of-thumb analysis of RMSE in the river water EC (JDEC) data shown in reference 530. Here, the number of hidden layers (HL) may be 200, mbs may be 256, a training period may be 953 days, and epochs (E) may be 100 to 12000. Here, epochs (E) may reach up to 12000 in increments of 100 from 100.

In addition, the training indicator optimization apparatus may present the basis for selecting optimal epochs (E) for the same mbs section.

In accordance with an aspect, the training indicator optimization apparatus may calculate optimal epoch (E) models through retraining and refitting. For example, the training indicator optimization apparatus may calculate optimal epoch (E) models through retraining and refitting for a range of 5000 to 8000 epochs (E).

Meanwhile, the training indicator optimization apparatus may more specifically set an optimal epoch (E) range based on a combined index (CI, RMSE×MAPE) for the predicted values (prediction) of the top 6 epoch (E) models and, at the same time, may construct an optimal training indicator model using the set optimal epoch (E) range.

FIG. 6 is a drawing for explaining a training indicator optimization method according to an embodiment.

In other words, FIG. 6 illustrates an operation method of the training indicator optimization apparatus according to an embodiment described above with reference to FIGS. 1 to 5C. In describing the training indicator optimization method according to an embodiment with reference to FIG. 6, contents overlapping with those described above are omitted. Referring to FIG. 6, in step 610 of the training indicator optimization method according to an embodiment, a pre-processor may construct a base dataset for environmental measurement data.

Next, in step 620 of the training indicator optimization method according to an embodiment, a dynamic feature processor may identify and extract dynamic features for the constructed base dataset through multi-resolution wavelet analysis and a dimensionality reduction technique.

In accordance with an aspect, step 620 of the training indicator optimization method according to an embodiment may further include a step of deriving wavelet energy distribution data on a time-frequency domain through multi-resolution wavelet analysis according to time domain resolution for the constructed base dataset and selecting PEDs by applying a dimensionality reduction technique to the derived wavelet energy distribution data. In addition, step 620 of the training indicator optimization method according to an embodiment may further include a step of extracting variation features according to a time change for each time domain resolution of the selected PEDs and extracting and quantifying dynamic features based on the extracted variation features.

Next, in step 630 of the training indicator optimization method according to an embodiment, driving force for environmental measurement data may be identified and evaluated based on the dynamic features extracted from the key feature group selector, and a key feature group may be selected in response to the evaluation result.

In accordance with an aspect, step 630 of the training indicator optimization method according to an embodiment may further include a step of, when a multi-resolution correlation between potential environmental driving force of the PEDs and the environmental measurement data is determined, performing correlation determination reflecting time delay and phase change between the potential environmental driving force and the observed data and selecting a maximum correlation scale between the potential environmental driving force and the observed data based on the performed correlation determination result.

In addition, step 630 of the training indicator optimization method according to an embodiment may further include a step of identifying driving force using a correlation between a wavelet energy ratio between the potential environmental driving force and the observed data and the selected maximum correlation scale, evaluating a relative contribution by processing linear coupling between a binding energy ratio of the selected maximum correlation scale and an explanatory power index of the dimensionality reduction model, and selecting the key feature group based on the evaluated relative contribution.

Next, in step 640 of the training indicator optimization method according to an embodiment, an indicator optimizer may receive the selected key feature group and the environmental measurement data as inputs and may control a plurality of training indicators of an environmental prediction model.

For example, the plural training indicators may include at least one of a training period (T), a minibatch size (mbs), the number of hidden layers (HL) and the number of optimal epochs (E).

In accordance with an aspect, step 640 of the training indicator optimization method according to an embodiment may further include a step of constructing a long-short term memory network model using a key feature group and environmental measurement data as inputs and pre-quantifying a plurality of training indicators based on the time-frequency domain of the key feature group.

In addition, step 640 of the training indicator optimization method according to an embodiment may further include a step of selecting at least one predictive model based on residual verification, based on complex model verification indicators of the observations measured from the environmental measurement data and the values predicted from the long-short term memory network model, and multi-resolution analysis of the residuals, and quantifying a plurality of training indicators pre-quantified based on one predictive model of the selected predictive models or a combined prediction model of two or more predictive models of the selected predictive models.

Further, step 640 of the training indicator optimization method according to an embodiment may further include a step of constructing an optimal training indicator model (e.g., generalized linear function model or regression model) using at least two training indicators of the plural quantified training indicators.

In conclusion, optimal training conditions according to data features and modeling purposes may be priorly determined by using the present invention.

In addition, training time reduction and intensive learning and overfitting on key features may be prevented even for general LSTM models by priorly determining optimal training conditions.

Further, predictive ability may be further improved through real-time model update on input data even for general LSTM models by priorly determining optimal training conditions and, at the same time, a more efficient environmental prediction model for the implementation of an integrated environmental monitoring, interpretation, prediction and response system using various environmental data may be provided by presenting a quantitative basis for selecting an optimal training indicator.

The apparatus described above may be implemented as a hardware component, a software component, and/or a combination of hardware components and software components. For example, the apparatus and components described in the embodiments may be achieved using one or more general purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an operating system (OS) and one or more software applications executing on the operating system. In addition, the processing device may access, store, manipulate, process, and generate data in response to execution of the software. For ease of understanding, the processing apparatus may be described as being used singly, but those skilled in the art will recognize that the processing apparatus may include a plurality of processing elements and/or a plurality of types of processing elements. For example, the processing apparatus may include a plurality of processors or one processor and one controller. Other processing configurations, such as a parallel processor, are also possible.

Although the present invention has been described with reference to limited embodiments and drawings, it should be understood by those skilled in the art that various changes and modifications may be made therein. For example, the described techniques may be performed in a different order than the described methods, and/or components of the described systems, structures, devices, circuits, etc., may be combined in a manner that is different from the described method, or appropriate results may be achieved even if replaced by other components or equivalents.

Therefore, other embodiments, other examples, and equivalents to the claims are within the scope of the following claims.

1. An apparatus for optimizing training indicators, comprising:
a pre-processor for constructing a base dataset for environmental measurement data;
a dynamic feature processor for identifying and extracting dynamic features for the constructed base dataset through multi-resolution wavelet analysis and a dimensionality reduction technique;
a key feature group selector for identifying and evaluating driving force for environmental measurement data based on the extracted dynamic features and selecting a key feature group in response to the evaluation result; and
an indicator optimizer for receiving the selected key feature group and the environmental measurement data as inputs and controlling a plurality of training indicators corresponding to an environmental prediction model.

2. The apparatus according to claim 1, wherein the environmental measurement data comprises hydrological-environmental time series data measured in real time, the hydrological-environmental time series data comprising at least one environmental data of hydrometeorological data, river water level data, groundwater level data, water quality data, temperature data, EC data, isotope ratio data, soil gas data and fine dust data.

3. The apparatus according to claim 1, wherein the pre-processor configures and arranges a data matrix according to observation items and observation time resolution of a dataset of the environmental measurement data as the base dataset, interpolates missing data for each time domain resolution or time observation interval for the arranged base dataset, noise-filters data of the interpolated base dataset, and standardizes and normalizes the noise-filtered results.

4. The apparatus according to claim 1, wherein the dynamic feature processor derives wavelet energy distribution data on a time-frequency domain through the multi-resolution wavelet analysis according to a time domain resolution for the constructed base dataset and selects potential environmental drivers (PEDs) by applying the dimensionality reduction technique to the derived wavelet energy distribution data.

5. The apparatus according to claim 4, wherein the dynamic feature processor extracts variation features according to a time change for each time domain resolution of the selected PEDs and extracts and quantifies the dynamic features based on the extracted variation features.

6. The apparatus according to claim 1, wherein the dimensionality reduction technique comprises at least one technique of principal/independent component analysis (PCA/ICA), time series factor analysis (TSFA), empirical mode decomposition (EMD) and multi-resolution state-space model (MRSSM).

7. The apparatus according to claim 4, wherein the key feature group selector determines a multi-resolution correlation between potential environmental driving force of the PEDs and the environmental measurement data and, in this case, performs correlation determination that reflects time delay and phase change between the potential environmental driving force and the observed data and selects a maximum correlation scale between the potential environmental driving force and the observed data based on the performed correlation determination result.

8. The apparatus according to claim 7, wherein the key feature group selector identifies driving force using a correlation between a wavelet energy ratio between the potential environmental driving force and the observed data and the selected maximum correlation scale, evaluates relative contribution by processing linear coupling between a binding energy ratio of the selected maximum correlation scale and an explanatory power index of a dimensionality reduction model, and selects the key feature group based on the evaluated relative contribution.

9. The apparatus according to claim 7, wherein the key feature group selector builds a pre-tuned LSTM network (well-tuned LSTM networks) that is trained using at least one of the PEDs and the key feature group, and verifies the potential environmental driving force using the pre-tuned LSTM network.

10. The apparatus according to claim 1, wherein the indicator optimizer builds a long-short term memory network model using the key feature group and the environmental measurement data as inputs and pre-quantifies the plural training indicators based on a time-frequency domain of the key feature group.

11. The apparatus according to claim 10, wherein the indicator optimizer selects at least one predictive model based on residual verification, based on complex model verification indicators of observations measured from the environmental measurement data and values predicted from the long-short term memory network model, and multi-resolution analysis of the residuals, and quantifies the plural pre-quantified training indicators based on one predictive model of the selected predictive models or a combined prediction model of two or more predictive models of the selected predictive models.

12. The apparatus according to claim 10, wherein the indicator optimizer constructs an optimal training indicator model using at least two training indicators of the plural quantified training indicators.

13. The apparatus according to claim 1, wherein the plural training indicators comprise a training period (T), a minibatch size (mbs), the number of hidden layers (HL) and the number of optimal epochs (E).

14. A method of optimizing training indicators, the method comprising:
constructing, by a pre-processor, a base dataset on environmental measurement data;
identifying and extracting, by a dynamic feature processor, dynamic features for the constructed base dataset through multi-resolution wavelet analysis and a dimensionality reduction technique;
identifying and evaluating, by a key feature group selector, driving force for environmental measurement data based on the extracted dynamic features from the key feature group selector and selecting a key feature group in response to the evaluation result; and
receiving, by an indicator optimizer, the selected key feature group and the environmental measurement data as inputs and controlling a plurality of training indicators of an environmental prediction model.

15. The method according to claim 14, wherein the identifying and extracting of the dynamic features further comprises:
deriving wavelet energy distribution data on a time-frequency domain through the multi-resolution wavelet analysis according to a time domain resolution for the constructed base dataset and selecting potential environmental drivers (PEDs) by applying the dimensionality reduction technique to the derived wavelet energy distribution data; and
extracting variation features according to a time change for each time domain resolution of the selected PEDs and extracting and quantifying the dynamic features based on the extracted variation features.

16. The method according to claim 15, wherein the selecting of the key feature group further comprises:
when a multi-resolution correlation between potential environmental driving force of the PEDs and the environmental measurement data is determined, performing correlation determination reflecting time delay and phase change between the potential environmental driving force and the observed data and selecting a maximum correlation scale between the potential environmental driving force and the observed data based on the performed correlation determination result; and
identifying driving force using a correlation between a wavelet energy ratio between the potential environmental driving force and the observed data and the selected maximum correlation scale, evaluating a relative contribution by processing linear coupling between a binding energy ratio of the selected maximum correlation scale and an explanatory power index of the dimensionality reduction model, and selecting the key feature group based on the evaluated relative contribution.

17. The method according to claim 14, wherein the controlling of the plural training indicators further comprises:
building a long-short term memory network model using the key feature group and the environmental measurement data as inputs and pre-quantifying the plural training indicators based on a time-frequency domain of the key feature group;
selecting at least one predictive model based on residual verification, based on complex model verification indicators of observations measured from the environmental measurement data and values predicted from the long-short term memory network model, and multi-resolution analysis of the residuals, and post-quantifying the plural pre-quantified training indicators based on one predictive model of the selected predictive models or a combined prediction model of two or more predictive models of the selected predictive models; and
constructing an optimal training indicator model using at least two training indicators of the plural quantified training indicators.

18. The method according to claim 14, wherein the plural training indicators comprise at least one of a training period (T), a minibatch size (mbs), the number of hidden layers (HL) and the number of optimal epochs (E).
